(19) United States
(12) Patent Application Publication
(10) Pub. No.: US 2011/0307171 A1
(43) Pub. Date: Dec. 15, 2011

(54) GPS Location Refinement Method In Environments With Low Satellite Visibility

(75) Inventor: Sheldon Waite, Mundelein, IL (US)

(73) Assignee: CONTINENTAL AUTOMOTIVE SYSTEMS, INC., Deer Park, IL (US)

(21) Appl. No.: 12/797,723

(22) Filed: Jun. 10, 2010

(51) Int. Cl. G01C 21/16; G01S 19/42

(52) U.S. Cl. 701/208

(57) ABSTRACT

A map data base can be used to assist GPS and other vehicle sensors (i.e., wheel speed, gyro, . . . ) in location estimation by allowing techniques such as determining if location is valid or invalid, best-fit determination, and others. Reduction in map data dependency can be achieved by using it only in areas where GPS position is not reliable. Reduction in map data dependency can be in the form of reduced size of map data base, or reduced data transmission in conjunction with anticipating future map needs, if map data is not stored locally on device.

### BACKGROUND

FIG. 1 is a graphical depiction of the constellation of global positioning system or GPS satellites that orbit the Earth in fixed planes, A-E. The GPS satellites transmit a signal in all directions, although there is a preferential orientation toward the Earth. GPS receivers calculate a location using trilateration.

A well-known problem with GPS signals is that they are not always available to a GPS receiver. FIG. 2 illustrates how signals from a GPS satellite can be blocked in an urban environment by buildings that block the signal 210 emitted from a GPS satellite 200. Tall buildings 220, tunnels or garages can obstruct the signal 210 from the satellite 200.

Areas where a GPS signal cannot be detected or where its signal strength is too weak to be used by a GPS receiver 230 are considered herein to be areas of poor GPS visibility. When the GPS signal is lost or too weak as happens in an area of poor GPS visibility, GPS navigation is not possible. A method or an apparatus for locating or deriving a geographical location upon the loss of a GPS signal would be an improvement over the prior art.

### BRIEF DESCRIPTION OF THE DRAWINGS

FIG. 1 depicts the GPS satellite constellation orbiting the earth;

FIG. 2 depicts GPS signal loss in an urban environment;

FIG. 3 depicts a block diagram of a system for improving GPS location using other data connections; and

FIG. 4 is a method for determining a location using GPS when signals are visible or a refinement method in environments with low GPS satellite visibility.

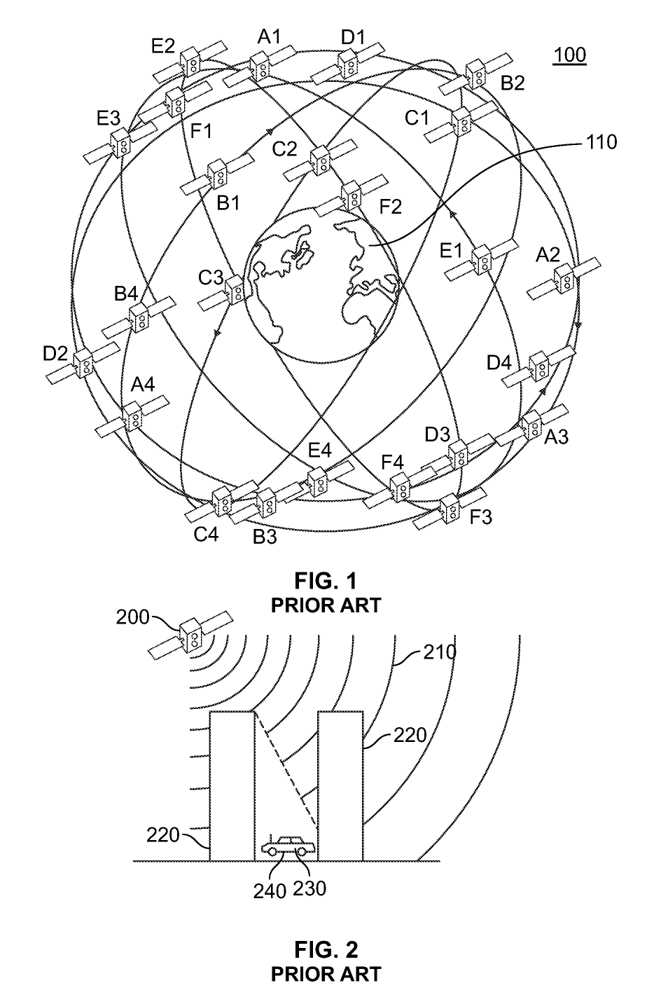

### DETAILED DESCRIPTION

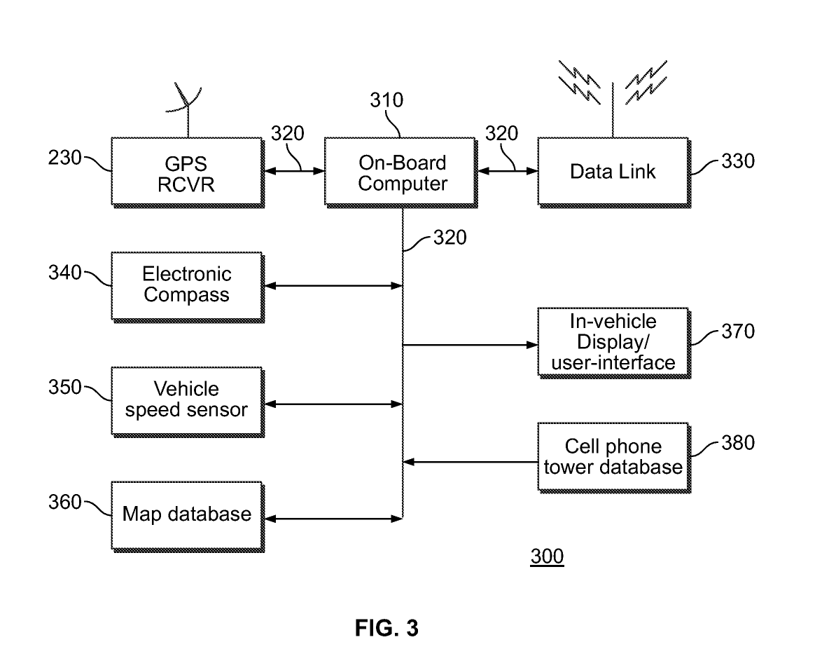

FIG. 3 depicts an apparatus for refining or determining a location upon entry in an area of poor GPS visibility. As used herein, the term “poor GPS visibility” means little or no signals that are received or detectable from one or more GPS satellites.

The apparatus in FIG. 3 includes a computer 310 operatively coupled to memory that stores executable program instructions and data. Such memory is so well known to those of ordinary skill in the computer art that a depiction of a memory device block in FIG. 3 is omitted for brevity and simplicity. Executable instructions and/or data can also be stored in semiconductor devices as well as magnetic disks. Executable instructions can also be stored on optical disks that include CD-ROM and DVDs. Map databases can be stored on magnetic or optical disks.

The computer 310 can be coupled to so-called on-board memory as well as memory that is accessible via the address, data and control bus 320 for the computer 310. Address, data and control busses for computers are well-known in the art and couple the computer to a GPS receiver 230. A description of the nature and operation of a computer bus is omitted for brevity.

In addition to being coupled to the GPS receiver 230, the computer 310 also communicates via the bus 320 with a two-way wireless communication device that provides a data link 330. The computer is therefore coupled to the data link device. In one embodiment, the data link device 330 can be embodied as a cellular telephone. In other embodiments a transceiver compatible with the I.E.E.E. standards 802.11(a), (b), (g) or (n) can be used. A WI-MAX transceiver or other two-way data communications device can also be used.

An electronic compass 340 provides a digital representation of the direction in which the vehicle moves. A vehicle speed sensor 350 provides a digital representation of the vehicle's instantaneous speed. A timer is provided by the computer 310. The compass, speed and time are considered to be sensor data that is provided by corresponding sensors/hardware well known to those of ordinary skill. A digitized map data base 360 and a user interface 370 are also coupled to the computer 310 via the bus 320, as is a cell phone tower database 380.

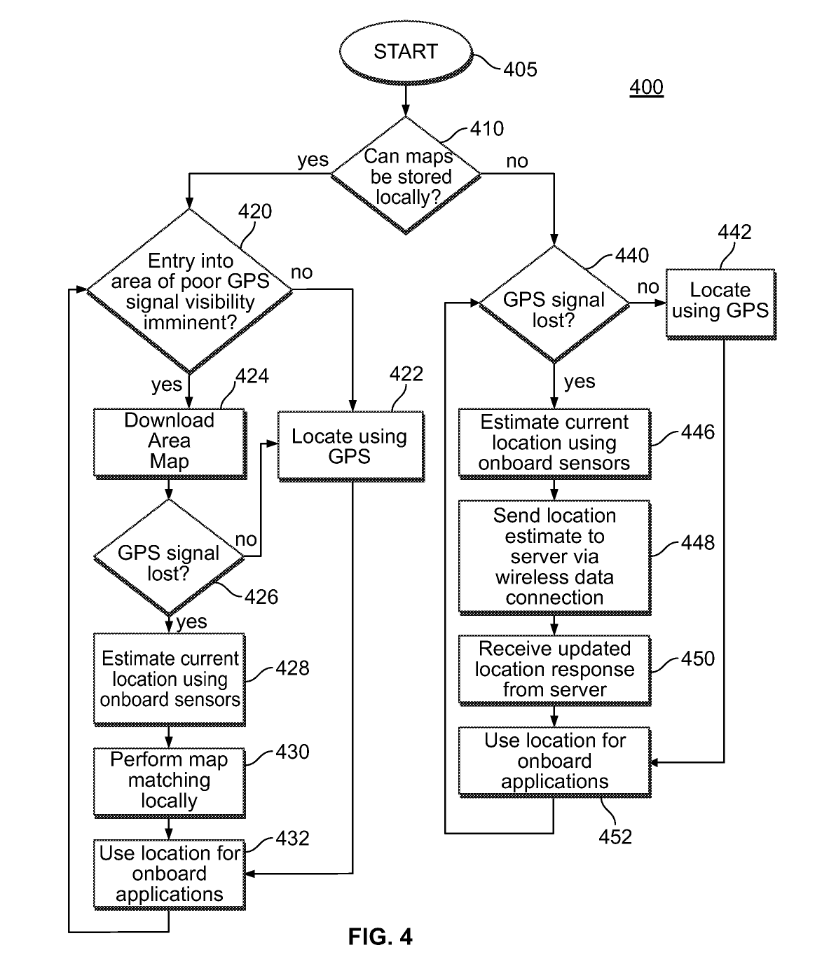

The on-board computer 310 executes program instructions that are stored in memory. The instructions imbue the computer with the ability to perform two similar methods of GPS location refinement in environments with a low GPS satellite visibility, both of which are depicted in FIG. 4. While FIG. 4 depicts a “start” step identified by reference numeral 405 because FIG. 4 is a flow chart, the methods 400 actually begin at step 410 wherein an initial determination is made by the computer 310 as to whether maps of the terrain surrounding the vehicle can be stored locally, i.e. within the vehicle or the on-board computer 310, or whether they will be accessed remotely.

If a map or maps of the nearby terrain can be stored locally, i.e. within the computer 310 or accessible to it, program execution proceeds to step 420, where the first step of a first method of GPS location refinement determines whether the GPS receiver 230 is entering into an area of poor GPS signal visibility. An area of poor GPS signal visibility is considered to be one where GPS satellite signal strength is too weak for a GPS receiver to use or where the signals are missing.

Areas of poor GPS visibility can be determined simply by measuring the received signal strength. In an alternate embodiment however, the map database 360 stores information that identifies areas that are known to have weak or missing GPS signals. By using GPS location information continuously or nearly continuously, the computer 310 can determine whether entry into an area of poor GPS visibility is imminent or whether it has already happened.

At step 420, if the GPS SSI indicates that signal loss is not imminent, a location is determined using GPS as indicated by step 422

At step 432, the determined location is used to display the vehicle's location, area landmarks, points of interest, etc. on a display device. The determined location is also provided various other on-board applications for use inside the vehicle 240, an example of which includes the so-called “ON-STAR” vehicle tracking system.

Referring again to step 420, if it is determined that the vehicle 240 is inside or entering an area of poor signal strength, the first location refine methodology downloads a map of the surrounding area using the last known good coordinates from the GPS receiver, if such a map is not already stored in the map database 360. The download of local area features and map data is provided by the data link device 330. The resolution of the downloaded map is a design choice and will effectively determine the time required to download the data necessary to determine using subsequent steps where the vehicle 240 is located.

At step 426, a second test is performed to determine whether the GPS signal has in fact been lost or is unusable. If the GPS signal has not been lost, program control returns to step 422 where the location is determined using GPS signals as before. If the GPS signal has been lost, at step 428 the vehicle's current location is estimated using the last known good GPS location and on-board sensors. The on-board sensors used for estimating the vehicles current location include the vehicle's electronic compass 340, speed sensor 350 and a timer.

The current location can be calculated or estimated using a compass, timer and a speed sensor to determine how far a vehicle has gone in various different directions. The calculation of displacement is a simple computation.

At step 430, the estimated current location that is determined using the on-board sensors is compared to maps stored in the map database 360. The map-matching step 430 checks the validity/accuracy of the calculated location against local terrain information in the maps. If for example the estimated location places the vehicle inside a building, body of water or other impossible location, software in the computer 310 can perform a best-fit correction of the estimated location. At step 432 the corrected location determined in step 430 is used for the on-board applications as described above. From step 432, program execution returns to step 420 in order to re-check whether the vehicle is still located within an area of poor GPS signal visibility.

Not all GPS-enabled navigation systems store local copies of maps. Some GPS-based navigation systems use a GPS receiver to determine latitude and longitude but rely on maps that are downloaded to the vehicle in real time and which are then displayed on a screen with the current location data determined using a GPS signal.

In FIG. 4, at step 410, if maps are not stored locally, i.e. within the map database 360 or otherwise directly accessible to the on-board computer 310, program control proceeds to step 440 where a determination is made whether the vehicle 240 is entering an area of poor GPS visibility or an area where the GPS signal is lost. The test performed at step 440, is the same test performed at step 426. If the GPS signal test of step 420 is negative, which means the GPS signal strength is still adequate to locate the vehicle, vehicle location is determined in step 442 using the GPS. Program control proceeds to step 452 where the determined location is made available for on-board applications as described with regard to step 432.

If it is determined at step 440 that the GPS signal is lost, the on-board computer 310 estimates the vehicles current location using the most recently-available GPS location and the aforementioned on-board sensors 340, 350 and a timer function provided by the computer 310 or an external timer not shown.

The estimated or calculated location is transferred by the wireless data link device 330 to a remotely-located server at step 448. Not shown in FIG. 4 is the determination of the vehicles current location and comparison using map matching which is performed at the server (not shown).

The server performs map matching as described with step 430 and sends the updated location back to the vehicle 240 via the wireless data link 330 as indicated by step 450.

Having received the updated location response a step 450, the method next displays and makes that updated location available for use by vehicle on-board applications as described above.

The map matching called out in step 430 and performed by the receiver as a result of step 448 is well known and described in various prior art publications. See for example the article entitled “IN-VEHICLE ROUTE GUIDANCE SYSTEMS USING MAP MATCHED DEAD RECKONING” by W. Clay Collier CH2811-8/90/0000/0359 copyright 1990 I.E.E.E. see also the article entitled “THE TRAVEL PILOT: A SECOND-GENERATION AUTOMOTIVE NAVIGATION SYSTEM,” by James L. Buxton, et al., published in the I.E.E.E. Transactions on Vehicular Technology, Volume 40, No. 1, February 1991 at page 41.

Paraphrased, map matching is a process by which small vectors present in an observed track are combined to produce larger vectors. The process essentially concactinates co-linear segments and breaks the concagnation at points where the vehicle has turned. The result of segmentation is a segmented track congruent with an observed track but composed of fewer elements.

Map matching compares a segmented track against a map database and a planned route to follow the progress of the vehicle and to correct for errors in the dead-reckoning process. The output of a map matching process is a list containing the current position, a current heading, a current speed, and a current map segment being traveled. Each element of the list corresponds directly to a node in the map database a current position and a degree of certainty are derived by comparing the segmented track to the map database and a planned route to find the path in the database which most closely matches the route in the segmented track. This is accomplished using a search tree called the historical track. The route of the historical track is the last location in which the vehicles location was known with a high degree of certainty such as just prior to GPS signal loss.

Those of ordinary skill in the art will recognize that areas of poor GPS visibility can be stored in the map database 360 as they are encountered. Over time, an accurate record of locations or areas of poor GPS visibility will be created in the map database. Over time, the steps of determining whether entry into such an area is imminent can be made simply by reading the database and comparing a current location to a previously-determined or known area of poor GPS visibility. This would allow optional configuration without data link 330.

The apparatus and method described herein is for purposes of illustration only. The true scope of the invention is set forth in the appurtenant claims.

What is claimed is:

1. A method comprising:
determining whether maps can be stored locally;
if maps can be stored locally, upon entry into an area of poor global positioning system (GPS) visibility:
downloading a map for the geographic area of poor GPS visibility, if a map for the geographic area of poor GPS visibility is not already stored locally;
determining a current location estimate using displacement information from sensors; and
performing map matching using the location estimate;
if maps cannot be stored locally, upon entry into an area of poor global positioning system (GPS) visibility:
determining a current location estimate using displacement information from sensors;
sending the current location estimate information to a server capable of map matching;
sending displacement information to the server; and
receiving updated location estimate from the server.

2. The method of claim 1, including the step of displaying the location estimate on a display device.

3. The method of claim 1, wherein the step of determining impending entry into a geographic area of poor GPS visibility includes the steps of:
determining a current location using GPS navigation;
comparing the current location with a map of known areas of poor GPS visibility.

4. The method of claim 1, wherein the step of determining impending entry into a geographic area of poor GPS visibility includes the steps of:
comparing a current location with entries in a map database.

5. The method of claim 1, wherein sending information to a server includes sending data wirelessly using a two-way wireless communications device.

6. The method of claim 1, wherein the step of determining a current location estimate using displacement information from sensors includes the steps of:
determining a first direction being traveled;
determining a first speed; and
measuring the time that the first direction is traveled at said first speed.

7. The method of claim 1, including the step of storing in a map database, information that identifies a location of poor GPS visibility.

8. The method of claim 1, wherein the map matching is comprised of:
obtaining a first location prior to entry into the area of poor GPS visibility;
calculating a second location as a net displacement from the first location, using sensor data;
estimating the validity of the calculated second location by comparing the calculated second location to terrain data from a map of the area of poor GPS visibility.

9. An apparatus comprising:
a computer;
a radio communication device operatively coupled to the computer;
a plurality of sensors operatively coupled to the computer; and
a memory device operatively coupled to the computer;
the computer being configured to:
determine whether maps can be stored locally in the memory device;
if maps can be stored in the memory device, and if a map for a geographic area of poor global positioning system (GPS) visibility is not already stored therein, upon entry into an area of poor global positioning system (GPS) visibility, download a map for the geographic area of poor GPS visibility using the radio communication device;
determine a current location estimate using displacement information from at least one sensor of the plurality of sensors; and
perform map matching using the location estimate;
if maps cannot be stored locally in the memory device, upon entry into an area of poor global positioning system (GPS) visibility:
determine a current location estimate using displacement information from at least one sensor of the plurality of sensors;
send to a server capable of map matching via the radio communication device:
current location estimate information;
displacement information; and
receive via the radio communications device, updated location estimate from the server.

10. The apparatus of claim 9, further comprising an in-vehicle display device, operatively coupled to the computer.

11. The apparatus of claim 9, wherein the computer is operatively coupled to a GPS receiver and wherein the computer is additionally configured to
determine a current location using GPS information from the GPS receiver;
compare the current location with a map of known areas of poor GPS visibility.

12. The apparatus of claim 9, wherein the computer is additionally configured to compare a current location with entries in a map database, which is stored within the memory device.

13. The apparatus of claim 9, wherein the computer is additionally configured to:
determine a first direction being traveled from at least one sensor of the plurality of sensors;
determine a first speed from at least one sensor of the plurality of sensors; and
measure the time that the first direction is traveled at said first speed.

14. The apparatus of claim 9, wherein the computer is additionally configured to store in the memory device, a map database having information that identifies a location of poor GPS visibility.

15. The apparatus of claim 1, wherein the computer is configured to perform map matching by:
obtaining a first location prior to entry into the area of poor GPS visibility;
calculating a second location as a net displacement from the first location, using sensor data; and
estimating the validity of the calculated second location by comparing the calculated second location to terrain data from a map of the area of poor GPS visibility.

16. A computer memory device storing computer program instructions, which when executed by a computer cause the computer to:
determine whether maps can be stored locally in a computer memory device and if maps can be stored locally, upon entry into an area of poor global positioning system (GPS) visibility, download a map for the geographic area of poor GPS visibility, if a map for the geographic area of poor GPS visibility is not already stored locally;
determine a current location estimate using displacement information from sensors; and
perform map matching using the location estimate;
determine that if maps cannot be stored locally, upon entry into an area of poor global positioning system (GPS) visibility, determining a current location estimate using displacement information from sensors;
send the current location estimate information to a server capable of map matching;
send displacement information to the server; and
receive updated location estimate from the server.

17. The computer memory device of claim 16, further comprising instructions which when executed, cause a computer to display of information on an in-vehicle display device.

18. The computer memory device of claim 16, further comprising instructions which when executed, cause a computer operatively coupled to a global positioning system (GPS) receiver to:
determine a current location using GPS information from the GPS receiver;
compare the current location with a map of known areas of poor GPS visibility.

19. The computer memory device of claim 16, further comprising instructions which when executed, cause a computer to compare a current location with entries in a map database, which is stored within the memory device.

20. The computer memory device of claim 16, further comprising instructions which when executed, cause a computer to store in the memory device, a map database having information that identifies a location of poor GPS visibility.
